(19) United States
(12) Patent Application Publication
(10) Pub. No.: US 2009/0125605 A1
(43) Pub. Date: May 14, 2009

(54) Method and System for Managing Folders of Email Accounts and Voice Messages

(76) Inventor: Michael Chung, Bayside, NY (US)

Correspondence Address: Michael Chung, 211-35 23rd Ave., # 1F, Bayside, NY, 11360, US

(21) Appl. No.: 11/990,460

(22) PCT Filed: Oct. 5, 2005
(86) PCT No.: PCT/US05/35761

§ 371 Date: Feb. 14, 2008

(51) Int. Cl. G06F 15/16

(52) U.S. Cl. 709/217

(57) ABSTRACT

A system for managing access to folders of an email account so that some folders can be viewed by Internet users other than the email account owner One way of access is simply by typing an Internet address in an Internet browser Contents can also be posted by any Internet user to those publicly accessible folders. One way of posting is simply by sending an email addressed to that folder A voice message management system manages multiple voice message boxes for each subscriber for later retrieval such as one main incoming message box and an advertisement voice message box for storing targeted advertising messages. The incoming voice messages are routed to their respective boxes based on their type, preferably without ringing the user's telephone at the time of delivery. An email and voice message management system for monitoring and managing respective inboxes, folders or boxes of multiple email and voice communication accounts.

### CROSS REFERENCE TO RELATED APPLICATIONS

This application claims priority to provisional application Ser. No. 60/616,106, filed Oct. 5, 2004, which is incorporated herein in its entirety by reference.

### FIELD OF THE INVENTION

This invention relates generally to data and voice communication, more specifically to managing folders of email accounts and voice messages.

### BACKGROUND AND SUMMARY OF THE INVENTION

This invention addresses several existing and anticipated problems. One is the need for a consumer friendly and socially acceptable method for prospecting and marketing by telephone (i.e., telemarketing). In the U.S., the Do-Not-Call (DNC) regulations made it prohibitive for telemarketers to continue their decades old marketing practices. The telemarketing industry, by some measure, had employed up to 6 million people and was a $70 billion (2000) industry. Telemarketing can provide productive public service through their personal, direct, and “high touch” messaging techniques and where the consumers have fast targeted personable offerings.

A characteristic of traditional telemarketing call was that it could not be easily distinguished from other personal or business to consumer service calls and often occurred at inopportune times; thus even if the target or prospect is interested in the message, the timing was often wrong. This invention will enable the delivery (perhaps, even to those on the DNC list, due to its consensual and voluntary access) and retrieval of such messages at the recipient's option or choice. It is “Choice™” opt-in, or opt-in at the point of delivery. As this method will depend largely on voluntary initiative by the target to engage (i.e., retrieve) the messaging channel, there is a natural hurdle or inertia to overcome for the marketer, thus, the onus is on the marketers to continuously deliver desired, properly targeted and rewarding messages.

Another problem is that due to digital technology and VoIP, the lowering telecommunication costs and ability to fake the call origination leads to “spoofing” and “phishing” where callers can purport to be the recipient's service provider such as financial and other services. Thus, there is a need to authenticate and differentiate certain commercial calls or messages from a service provider to their customers.

This invention will provide differentiation, category sorting and storage of select call messages. For example: it will have at least one separate inbox or “voice” mailbox for select target marketing messages; other mailboxes can be for Location Based Marketing (LBM) ads, public announcements, or the like.

Still others are folders created by the user where, as a service by the system, certain personal data is stored and uploaded from their devices (e.g., pictures, video, memos, announcements, e.g., directions to house and such) are available for access by others, e.g., via online access (e.g., if VoIP service) through a limited access (only certain user set folders are open) web page associated with the user's account. The invention's voice message storage system, in one embodiment, will be appended to the user's regular voice messaging system so that the user can more easily access the retrieval system, but can be otherwise self-contained (i.e., a “virtual-private” message system). Thus, there can be private (only user access using ID and password), protected (passworded only) and public (non-passworded) voice mail boxes, and this system can be applied to inboxes or folders (Rack™, Rackmail™) in email as well, where there are public and protected folders that are accessible to others on permission and user set rule basis.

The rackmail invention uses the basic email protocols as its foundation and creates a simple to use interface for the management of many applications while simultaneously providing access to a group of users (i.e., “viewers”). In a way, this method converges two popular web technologies that are somewhat complimentary in nature and completely opposite in usability, which are email and blogging; it can be seen to be “super email” or “blogging lite”, depending on the usage. The method and system will include: (1) ability to manage multiple email accounts across a disparate number of service providers; (2) ability to create the “racks” or pseudo folders (“public” folders will be viewable to anyone, “protected” folders will require password), which access user created folders on service provider's email storage; (3) providing an easy to use email driven name finding and sending emails (i.e., if permitted by user to accept “outside” emails) in these folders (e.g., golf userid@rack-mail.com for golf folder) and for locating such folders of the email account owner or “poster” (as the email address is one of the most known ID and easiest to remember); (4) providing an easy to use web interface to enable users, with permission, to access folders from the primary user (this access acts as a proxy to the email account and handles security and authentication to ensure that unauthorized access to other folders or emails doesn't occur); (5) providing a simple management facility enabling a ‘Universe’ to see email in folders, which constitutes everyone with a rack email id, (this Universe is similar to a blog); (6) providing a way to use IMAP protocol from a standard mail application such as Outlook to access the rack-mail folders without requiring the web interface.

Additionally, while blogging requires a user to learn specific tools on creating a blog page, the present “rack” invention only requires users to know how to use email. Every feature available in Blog would be available in email. Rackmail could even borrow the concept of blogrolling. Blogrolling is when a blog contacts a server to notify users that the blog has been updated. What can also be installed is the concept of “you got mail” or “new rack mail”. When the rack is updated, a note can be sent to the user or viewer via an identified source, or if they have installed a rack folder in their email client it would automatically get updated. Also, it is possible to create a blog interface that ties into a Rack system and to serve the same purpose as blogging, but the foundation is emails. Therefore, visitors and viewers can think they are blogging (e.g., when a visitor leaves a comment, it is loaded to the page via email in the background) when in fact, they would be using the racking method.

The present invention is related to U.S. Application Pub. No. US2002/0188689 entitled “Methods and systems for electronic mail, internet target and direct marketing, and electronic mail banner”, the content of which is incorporated herein by reference.

One object of the invention is to provide special handling, differentiation and delivery for select telecommunication and VoIP based messages.

Another object of the invention is to provide means for a message to a recipient to be delivered and directly stored instead of first ringing or getting to recipient's phone.

Another object of the invention is to provide a separate category based, storage or inboxes of both voice mail and data messages, in particular, marketing messages.

Another object of the invention is to provide means to store video, pictures and memos taken via the phone to their respective online storage inboxes, and where some are accessible or open to be read/write, on permission based, by others;

Another object of the invention is to provide means for open or publicly accessible (open, or permission base) protected (password) accessible folders using email technology and for such folders to have individual URL (e.g., www.emailserviceprovider.com/userid/folderid)

Another object of the invention is to provide a link from the select message to the marketer's CRM center, and where when the target user retrieves a message and wants to speak immediately with the marketer, to provide the target profile and subject of the call to the marketer's representative.

Another object of the invention is to provide a visual mark and/or distinctive ring tone for authenticated messages and calls.

Another object of the invention is to provide a feedback, i.e., rating system—from the recipient of an advertisement message to the Sender.

Another object of the invention is for a marketer (or rack owner) to have an advertising specific folder (“golf”) and to have unlimited number of the public to have also a corresponding “golf” folder (pseudo or actual) on their email client and to have access to the contents of the marketer's “golf” folder by clicking on their golf folder and for the marketer to update the contents by emailing to the folder, e.g.: golffolderID.accountname@emailserviceprovider.com.

A further object of the invention is to provide means for delivering (bulk delivery or targeting) a common message to a defined group.

Yet another object of the invention is to provide authentication of the message and/or caller.

Still yet another object of the invention is to provide means for the sender and the system to control the location, placement or live and dead dates of a message in the folder.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings (not necessarily to scale) constitute a part of this specification and include exemplary embodiments to the invention, which maybe embodied in various forms.

FIG. 1 is a diagram of major components for facilitating the special handling, delivery, authentication, storage and retrieval and display of a message according to an exemplary embodiment of the present invention.

FIG. 2 is a flow process for facilitating the special handling, delivery, authentication and storage of a message according to an exemplary embodiment of the present invention.

FIG. 3 is a flow process for retrieval of a message according to an exemplary embodiment of the present invention.

FIG. 4 is a flow process chart for the message retrieval and the storage and structure for message categories and retrieval according to an exemplary embodiment of the present invention.

FIG. 5 is a diagram of components and process of an authentication process according to a exemplary embodiment of the present invention.

FIG. 6 is a block diagram of an email access management system according to the present invention.

FIGS. 7A-7D are screen shots of sample web pages of an exemplary embodiment of FIG. 6.

FIG. 8 is a web page displaying means for usage as a business listing.

### DETAILED DESCRIPTION OF THE PREFERRED EMBODIMENTS

Detailed descriptions of the preferred embodiment are provided herein. It is to be understood that the present invention may be embodied in other forms. Therefore, specific details disclosed herein are not to be limiting, but to cover such alternatives, modifications, and equivalents as may be included within the spirit and scope of the invention as defined by the claims.

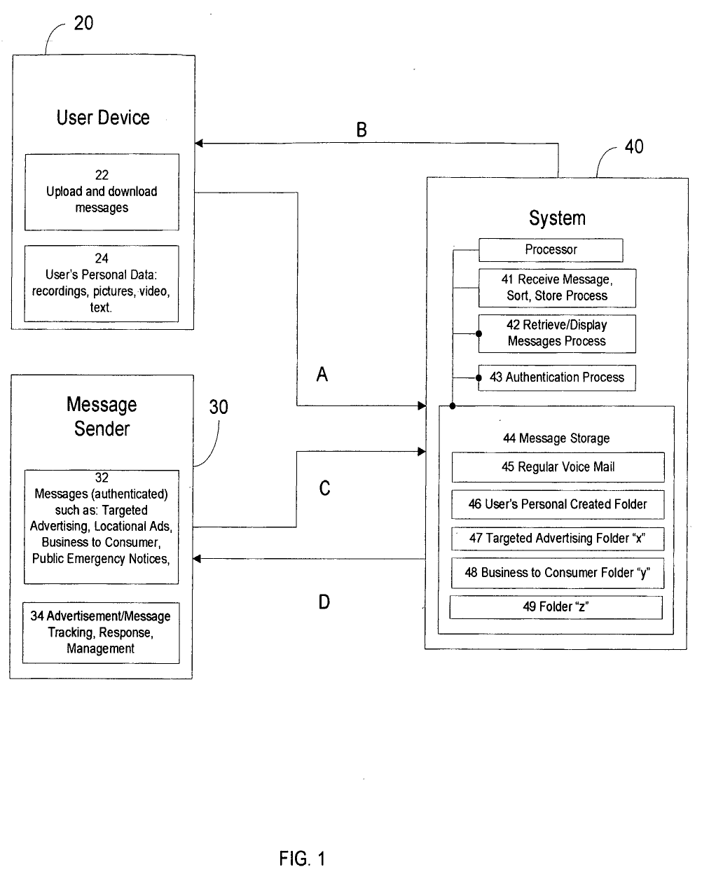

Some figures show both components and process or functions. FIG. 1 is a diagram showing the basic components and functions of the present invention. Also, while it shows certain functions and processes (e.g., 32, 34) grouped in one component (30), in practice the functions can be located separately.

FIG. 1. The system comprises at least one external sender's device 30, a message “gateway” handling, authentication, delivery and storage system 40, and user's device 20. The sender's device has process 32 for batching C (individually or bulk) messages and targeting (i.e., addresses or phone number) of the recipients, and message management 34 (tracking, open or view rate, marketing campaign metrics and administration, etc. D) functions. The system 40 has processes 43 for authenticating the sender and/or the message, then sorting 41 and storage 44 management, folders or inboxes 45, 46, 47, 48, 49 and retrieval and display process 42.

Elements 41-43 constitute a message processing program that handles routing of voice messages based on the types of voice messages being received from a sender and handles retrieving of stored voice messages according to selection/input from subscribers. For example, when checking regular voice messages, the subscriber may be prompted to go to a different message box to listen to other messages such as emergency messages, targeted advertisement messages and the like. In a preferred embodiment, the message processing program routes the voice message to one of the different message boxes without any alert associated with a telephone call such as ringing or vibrating because the voice message is not a telephone call, but simply something that should be delivered to the subscriber.

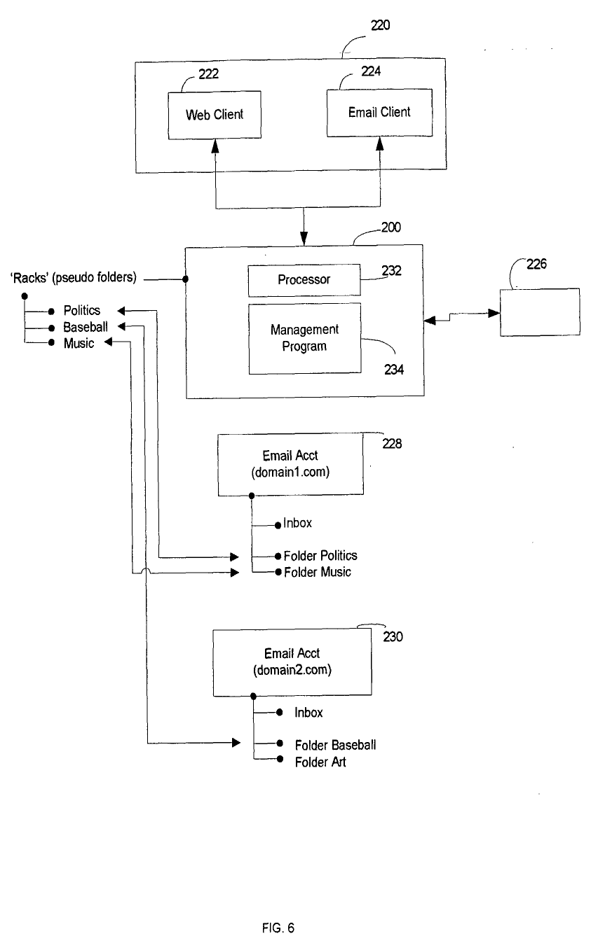

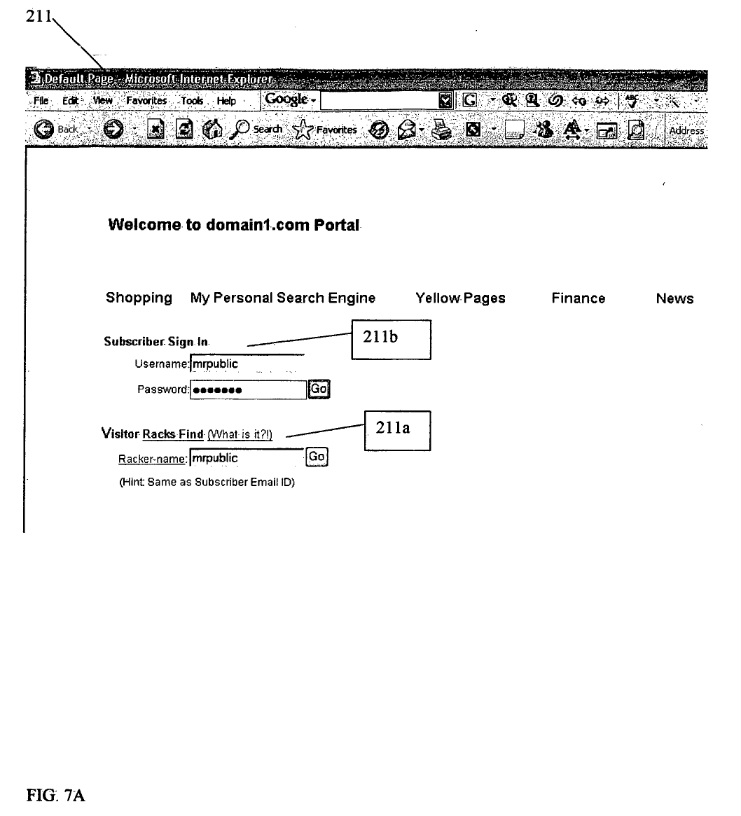

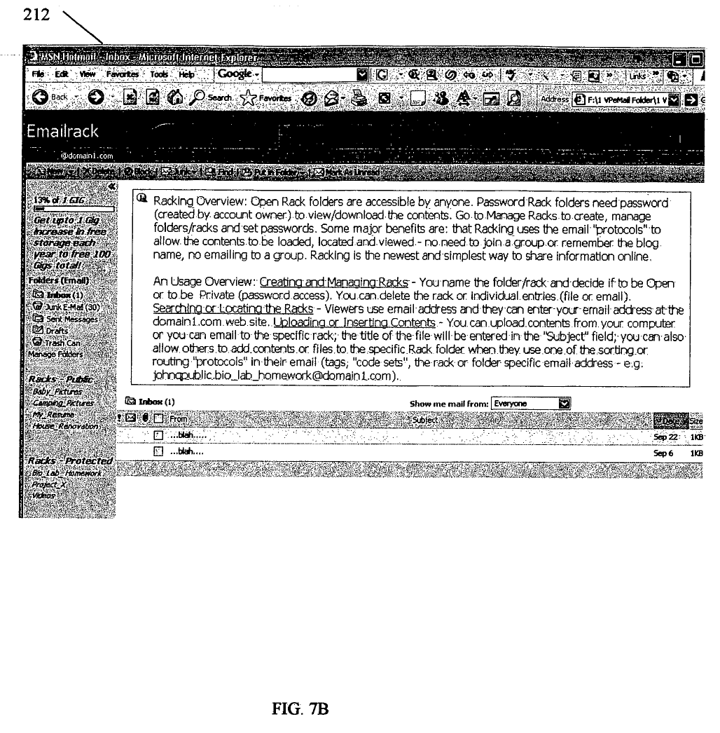

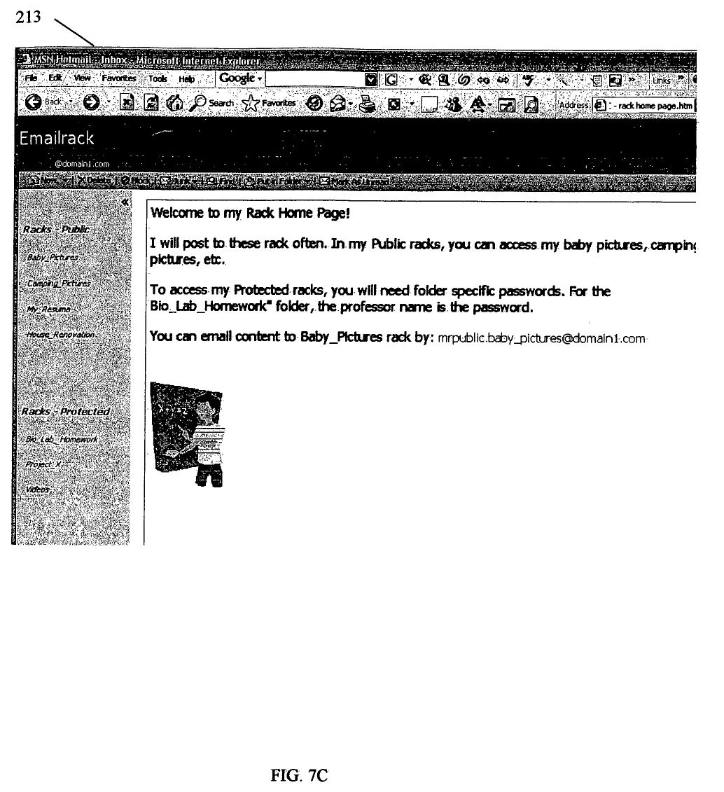

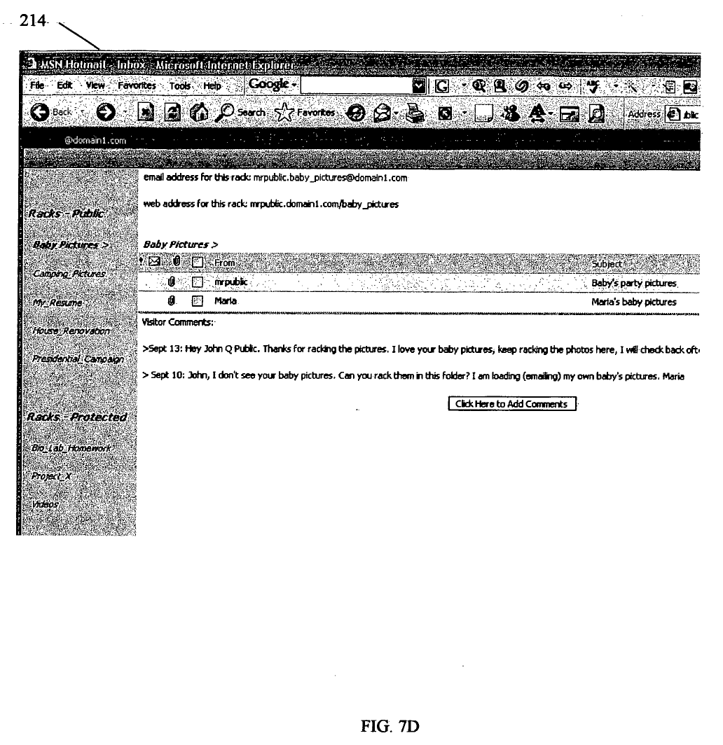

User device 20 such as a personal computer, telephone or a PDA has various functions 22 for retrieving B and uploading A, personal data 24. Also, folder 49 can be representative of a user created “open” folder or “rack” in FIG. 6, where such can hold content accessible by others using the methods in FIGS. 6 and 7. Also, a shortcut to any of the folders 47, 48, 49 can be separately located on the desktop or wireless web device of the User or viewer and such can be made to blink or otherwise alert the User or viewer when the contents of the rack is updated (e.g., a “high priority” email is sent to the folder).

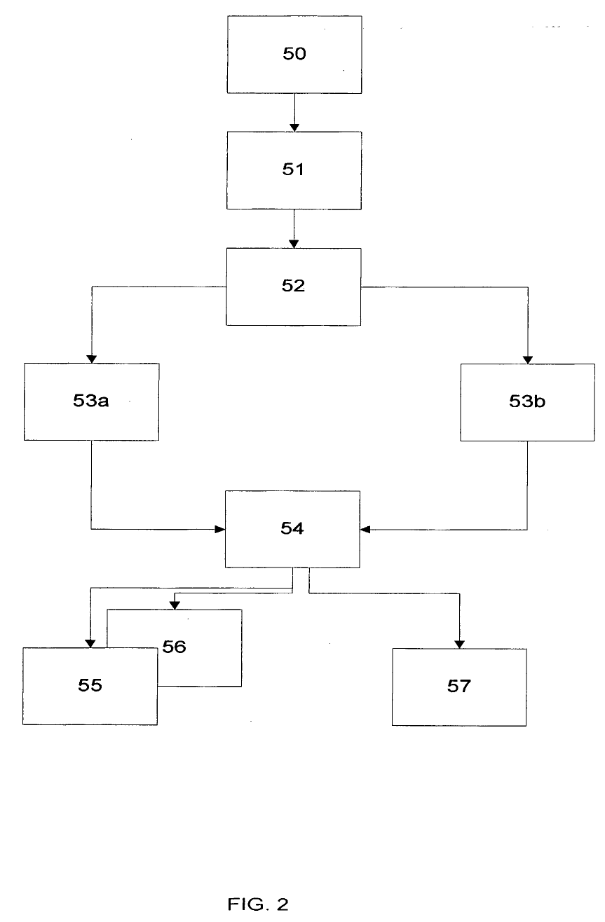

FIG. 2 is a process flow for sending a message. Sender creates message or ad file 50 such as a voice advertisement message. Sender logs 51 on to System 40, System validates Sender and Sender creates a “x” marketing campaign “x folder” or account. Sender uploads or batches 52 message to the x folder and also batches 53a recipient(s) addresses (telephone number(s), VoIP address(s)) or if does not have the addresses, selects 53b—from a menu or directory list provided by the System—demographic profile(s) (e.g., geographic, psychographic, etc.) of the desired recipients. System then delivers, stores 54 the messages to the appropriate category folder or voice mail boxes of the recipients 55, 56 or 57 a group box.

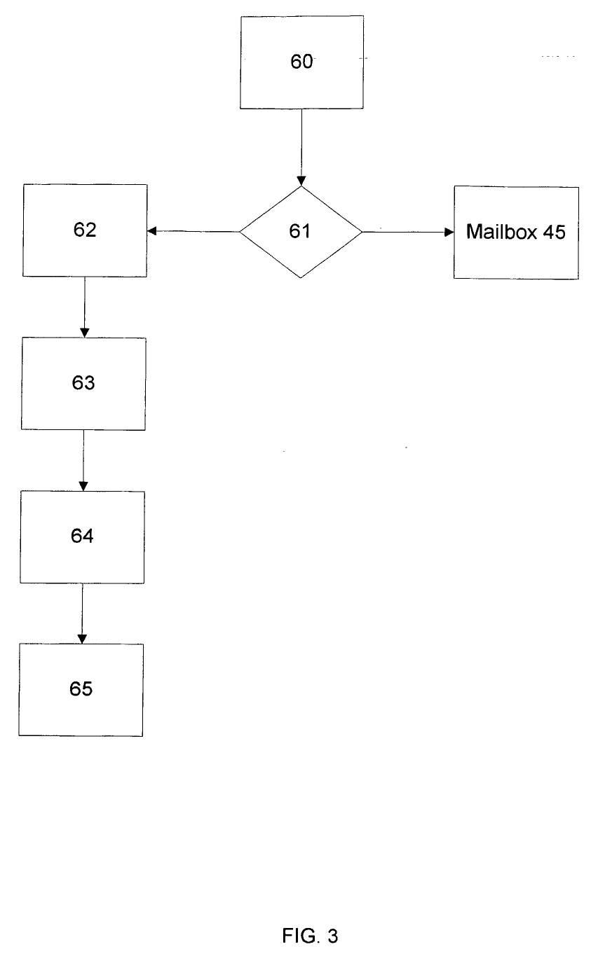

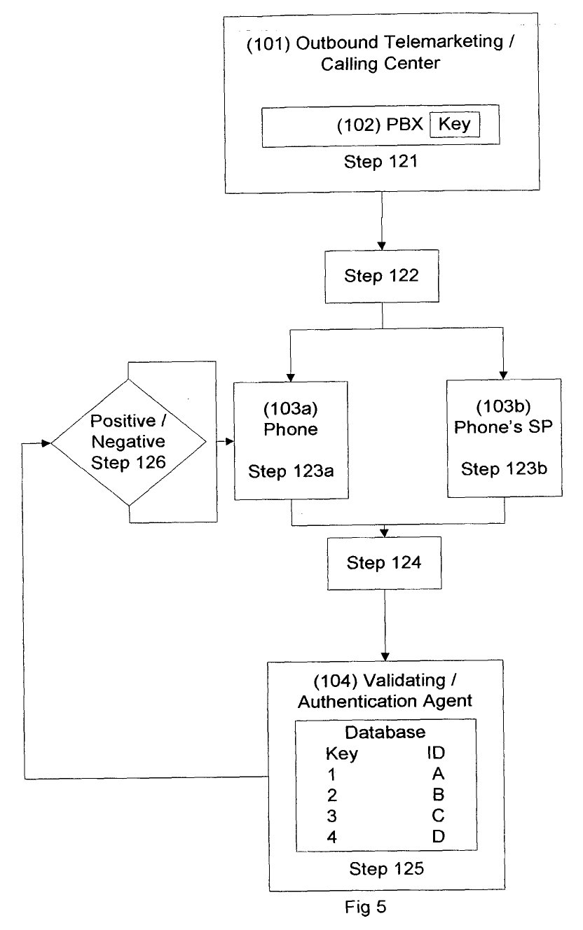

FIG. 3 is a process flow for a user to retrieve a message created in process 50. In step 60, User connects using 42 to the system's message retrieval administration function 44 from phone 20. In step 61, the user can either continue to regular message function or mailbox 45 or alternatively go, step 62, to the separate mailboxes 46, 47, 48, 49. In step 63, user retrieves (B, in FIG. 1) message “50” from “mail box 47”. In step 64, user “presses “star” key” on phone to be directly linked to CRM center of sender “30” of the message and is identified to the sender. In step 65, the CRM center of the sender searches its database and retrieves the message 30 and profile of user displays such on the screen of the CRM representative. And optionally, if the CRM center is located outside of the user's country—and if in the interest of full disclosure to the user and the fact that VOIP calls dialed to a local phone number will display the local phone number (or an “800” area code), even though destination is an oversea CRM center, thus, can be misleading to the recipient—an automated recording plays as part of the greeting: “thank you for responding to our message “50”, you are being connected to our CRM center in “country y””; for outgoing CRM calls, a country of origin service call notice can be inserted using a process similar to step 122 of FIG. 5. (This is analogous to country of origin mark on products, thus, for outsourced services as well).

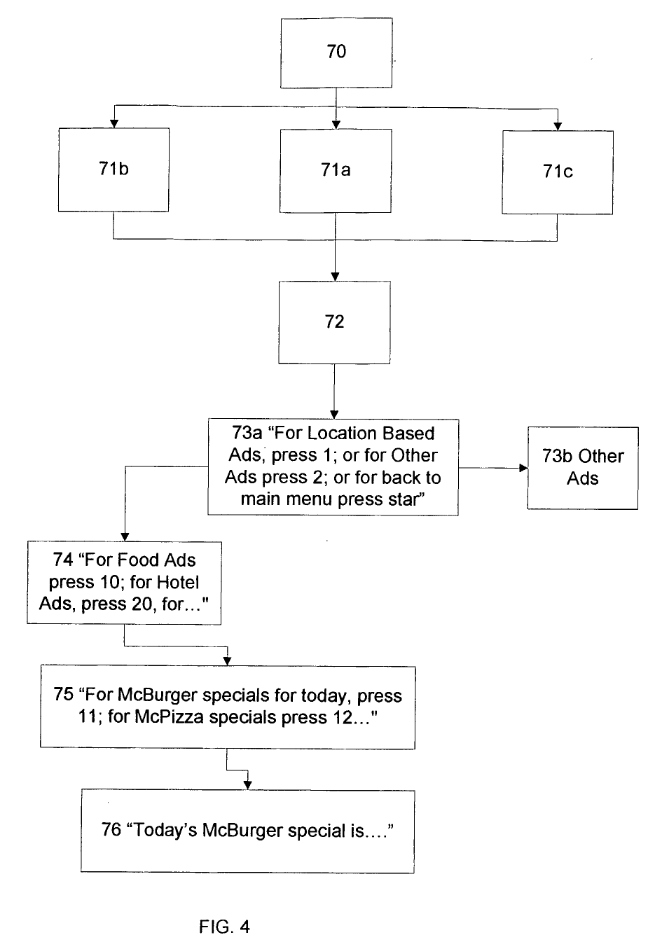

FIG. 4 is process for storage of an ad message by a sender, its various storage methods, message levels structure and retrieval by a user. In step 70, user accesses the system 40 using a variety of methods: a “toll free” dedicated number (not necessarily specific to the user), step 71a or a dedicated speed dial preprogrammed into the phone, step 71b; or via a web browser using a standard Internet protocol, step 71c. In step 72, the system uses Caller ID and location based mapping to determine the id of the user and the location of the user's wireless phone, in order to access the appropriate location ads storage. In step 73a and 73b, the user accesses the message menu and makes selections. In steps 74, 75, and 76, the user drills down to choices. A Message Survey function, database and query steps are shown at steps 77 to 79, where the feedback is analyzed for improved targeting and marketing metrics.

FIG. 5. An outbound call center 101 has a software installed at the PBX system 102 which will generate or acquire from code provider 104 and add the unique authentication code at the time of outgoing calls. This can be done automatically or on a call-by-call basis. The receiver's phone 103a or the phone's service provider 103b has a software to filter for such code. Validation or authentication agent 104 generates and validates the code. In step 121, code is acquired and added to the outgoing call data. In step 122, the call is sent using an identifier such as a digital certificate indicating who they are, and included is the key or digital signature for that sender. In step 123b, upon receipt of the call at phone service provider's “call routing center” 103b (alternatively at the phone or VoIP computer device, step) 123a)—the call's data is filtered for such code—and the software immediately sends, in step 124, the key and identifier to a third party 104 that acts as a validation agent. In step 125, Validation agent does a lookup on the key and determines if the ID sent matches what is in the Database. If yes, in step 126, it sends back to the phone a positive, if no or inconclusive, it sends negative. Based on positive or negative, phone will indicate with a distinct tone, word or symbol, indicating that the caller has been accurately identified. Further, if the call is from a telemarketer and does not wish to ring the Phone 103a, the call can be sent to a separate and dedicated voice mailbox for later retrieval by the user.

In one embodiment, the call is a digitized voice message that contains a destination identifier, using for example an XML tag, which identifies to which message box the message should be routed to. The XML tag may contain the name of the destination message box such as “Advertising”. The voice message may also contain an instruction that instructs the system 40 to erase the message if it has not been listened to within a certain period of time. Also, the message processing program 41-43 is capable of storing other message types that are not voice messages since digitized voice messages are treated simply as a data file. For example, the program may store picture files, motion picture files, text files and the like for later retrieval by the subscribers.

According to another aspect, a method and system of managing access to folders of email accounts of subscribers to both the subscribers and non-subscribers such as the public is provided. This invention uses the well-known concept of email as a basic foundation for communication as well as posting sharing information on the Internet. As such, the invention allows any Internet user, whether novice or sophisticated, to use an email to post content on a website similar to blogging without using any specialized programs or technical knowledge. The solution uses the basic email protocols as its foundation and creates a simple to use interface for the management of many applications while simultaneously providing access to a group of users. The solution provided, called RackMail, converges two popular web technologies that are somewhat complimentary in nature and completely opposite in usability. RackMail provides the following: (1) single access to manage multiple email accounts for each subscriber across a disparate number of service providers; (2) ability to create “racks” (pseudo folders), which access existing folders on service provider's email storage without actually storing the content; (3) provide an easy to use email driven name for the purposes of posting content in these folders which is accessible through the Internet (e.g., using the email address of ‘public.johndoe@rackmail.com’ for posting and locating content to the “public” folder for subscriber named “johndoe” which is then accessible by any Internet user); (4) provide an easy to use web interface to enable users, with permission, to access folders from the primary user; this access acts as a proxy to the email account and handles security and authentication to ensure unauthorized access to other folders or emails doesn't occur; (5) provide a simple management facility enabling a ‘Universe’ to see email in folders, which constitutes everyone with a Rackmail id. This Universe is similar to a blog; and (6) provide a way to use IMAP and SMTP protocols from a standard mail application such as Outlook to access rackmail folders without requiring the web interface.

FIG. 6 shows a functional block diagram of the present email access management system 200. The system 200 comprising a processor 232 and management program 234 is connected to a plurality of user computers such as 220 which is capable of accessing the Internet and the system 200 using a web client (e.g., Internet browser) 222 and email client (e.g., email program such as Outlook) 224 through standard Internet protocols such as TCP/IP, SMTP and IMAP as is well known in the art.

The management system 200 is also connected to various servers providing email services. Through a standard Internet connection, the system 200 connects to a server servicing email account 228 which is accessible by a domain name “domain1.com” and server servicing email account 230 which is accessible by a domain name “domain2.com”. Each person may have multiple email accounts at various email account providers. In the example shown, user “jdoe” owns an email account at domain1.com and also at domain2.com. At domain1.com, the user jdoe has three folders: “Inbox”, “Politics” and “Music” while at domain2.com, jdoe has three folders named: “Inbox”, “Baseball” and “Art”.

When the user subscribes to the rack email management system 200, the various account access data that are necessary to access the email systems at domain1.com and domain2.com are set up and stored in storage device 226. The data may include such items as server name, user id, and password. The racks in the system 200 are pseudo-folders that correspond to the folders that exist in the subscriber's email accounts. The racks “Politics”, and “Music” correspond to email folders “Politics”, and “Music” in domain1.com and the rack “Baseball” corresponds to email folder “Baseball” in domain2.com. Preferably, the racks are folders that do not physically store any emails unlike the folders that exist at email servers domain1.com and domain2.com. In other words, the rack system 200 acts as a proxy email system with no storage.

The storage device 226 stores access authorization for each folder of each account subscriber and the management program 234 controls access of those folders by Internet users according to the stored access authorization. For example, the “Politics”, “Baseball” and “Music” racks are marked by the account subscriber as “public” that can be accessible by any Internet user. It is important to note that some racks may be marked as private and some as semi private. If marked as private, then only the rack account subscriber that set up his email accounts could have access to those folders. If marked as semi-private, then the rack subscriber would have to specify a list of other rack subscribers who can access such folders or specify a particular password for that folder which is required by Internet users wanting to view that folder content.

There are many ways to access the rack content through the Internet. One way is to use a web client 222. User “bsmith” uses the web client 222 to connect to rackmail system 200 using a URL. For example, bsmith types in “http://jdoe.rackmail.com”. The URL resolves and identifies it as a request for a listing of all rack that are accessible to the public. The management program 234 of the rackmail system 200 then retrieves the associated email information from both domain1.com and domain2.com and returns the list of all non-private folders for display back to user bsmith. The Internet user bsmith can directly access the folder by, for example, typing in “http://jdoe.rackmail.com/politics”. Alternatively, the URL can be in the form of “http://www.rackmail.com/jdoe/politics”. The URL resolves and identifies it as a request for the politics rack which corresponds to the “politics” folder residing in the server at domain1.com. The management program 234 of the rackmail system 200 then retrieves the associated email information from domain1.com, folder “politics”, and returns all items in that folder for display back to user bsmith. As the politics folder was marked as public, the user bsmith can advantageously access the politics content without any password or any account access information for the email account located at domain1.com. Once the list of emails in that folder is displayed, the user can click on any email to display the individual content of the selected email.

It is important to note that the location of the system 200 relative to the servers servicing domain1.com and domain2.com is not important. In fact, it is very possible that the system 200 and the server for domain1.com may be provided by the same provider and have the same domain name and possibly located even in a single computer system. For example, if domain1.com and the rack system 200 are offered by a single service provider, then the politics and music folders can be accessed by any Internet user by typing, for example, an Internet address of “http://jdoe.domain1.com/politics” and “http://jdoedomain1.com/music”, respectively.

Another way to access the rack content is through an email client 224. User bsmith uses the email client 224 to connect to the rackmail system using an IMAP connection. User sets up the email client to access the politics rack. To do so, the standard IMAP would be modified slightly to recognize the folder information. As an example, the IMAP can be modified to recognize the folder information by filtering the first word that appears in an email address format. The email address to retrieve the politics content from jdoe's email account at domain1.com would be “politics.jdoe@rackmail.com” in which the rack system 200 server can be accessed by “rackmail.com”. The Rackmail system 200 then retrieves the associated email information from domain1.com, folder X1, and returns all items in that folder for display back to user bsmith.

Various methods of posting content to the email accounts for access by the Internet users will now be described. One way to post content is by using a web client 222. User bsmith uses web client 222 to connect to rackmail system 200 by typing in a URL. For example, to access jdoe's baseball rack, a user types in “http://jdoe.rackmail.com/baseball”. The URL resolves and identifies it as a request to post information on the baseball rack. The management program 234 retrieves the associated access authorization stored in the storage device 226. If it is at least semi-private, then the rackmail system 200 either requests a password or compares the user's subscriber ID in the list previously set up by subscriber jdoe. Once the posting access is granted, the user can submit the information to be posted using a standard post submission procedure (normal website operation). The management program 234 then takes the posted information, formats it into an email with an email address of “Y1.jdoedomain2.com” and sends the associated email information to domain1.com, folder Y1 using the IMAP. As discussed above, the IMAP should be slightly modified to recognize the folder name in the destination email address field and to properly route it to the correct folder.

FIG. 7 illustrates a flow processes and sample web pages according to an exemplary embodiment of the present invention executed by the management program 234 in the case where the same service provider is providing the rack system 200 and email service at a URL location of “domain1.com”. FIG. 7A shows web page 211 which represents the first screen displayed when the above URL is typed into the web client 222. If an Internet user other than the subscriber “mrpublic” is interested in viewing the folders of mrpublic, then the user can search for his name by typing in his email name. If the subscriber “mrpublic” desires to log into his email account at domain1.com, then the user name and password are supplied through 211b. The result of the successful login as a subscriber is shown as web page 212 in FIG. 7B. The web page 212 shows the subscriber's main folders Inbox, Public folders Baby_Pictures, Camping_Pictures, My_resume, House_Renovation and Presidential_Campaign, and Protected folders Bio_Lab_Homework and My_Movies. The Inbox is a private section that can only be accessed by the subscriber himself The Public folders are accessible by any Internet user by simply typing in a URL address of “mrpublic.domain1.com/public folder name”. The Protected folders are accessible by any Internet user provided that a correct password is supplied.

FIG. 7C is a main web page 213 of mrpublic that can be accessed by any Internet user by typing, for example, “mrpublic.domain1.com”. The webpage 213 displays the list of available folders on the left portion of the screen and optionally displays an introductory page as shown in the main part of the display. Such introductory page can be designed and uploaded to the system 200 when the subscriber mrpublic subscribes to the rack email management system. When the Internet user clicks on the Baby_Pictures folder or types in an URL address of mrpublic.domain1.combaby_pictures, web page 214 as shown in FIG. 7d is displayed on the Internet user's computer screen.

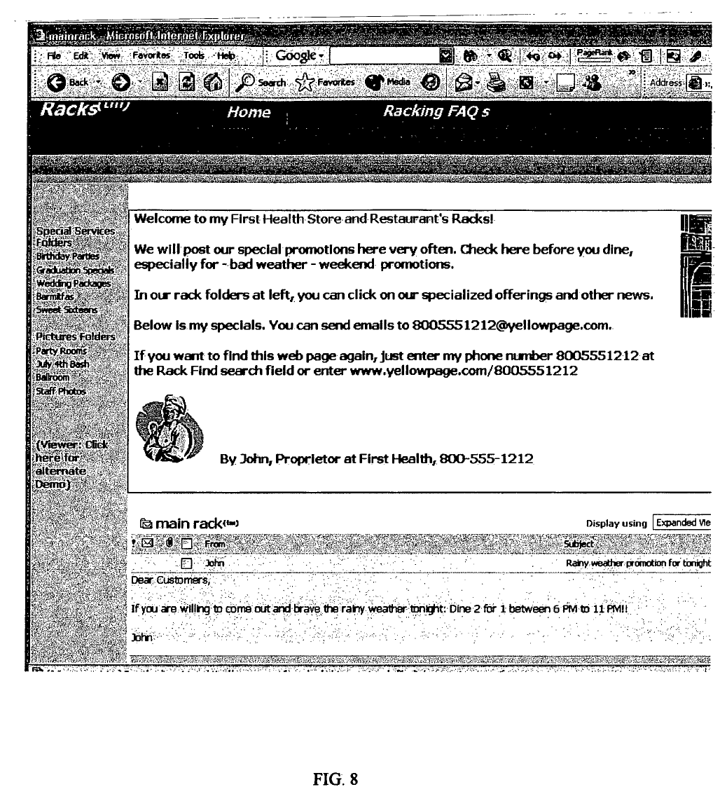

FIG. 8 is home page of a business which is similar to FIG. 7C, except that the introductory page is displayed along with the emails at the bottom. The user name for this business is “8005551212” which is conveniently the telephone number of a business called “First Health”. The listed emails are sent using an email address of 8005551212.homepage@domain1.com.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A system for managing access to folders of email accounts for a plurality of email account subscribers, the system comprising:
a storage device operable to store, for a plurality of account subscribers, account access data of at least one email account of each account subscriber, each email account having an inbox folder and at least one second folder other than the inbox folder;
a processor;
a management program executed by the processor and operable to:
receive from an Internet user a request for information concerning the email account of a particular account subscriber through the Internet without logging in to the email account;
retrieve, responsive to the received request for information, the content of the second folder from an email server servicing the email account for the particular account subscriber based on the account access data stored in the storage device; and
send to the Internet user the retrieved content.

2. The system according to claim 1, wherein:
the request for information concerning the email account includes a URL containing a domain name, a user name and a folder name;
the management program retrieves the content of the second folder and sends the retrieved content based on the received URL.

3. The system according to claim 2, wherein the URL is in the form of www.domain name.com/user name/folder name.

4. The system according to claim 1, wherein an access authorization to the second folder of the email account for the particular account subscriber indicates a public folder and the management program makes the second folder accessible by any Internet user.

5. The system according to claim 1, wherein the particular email account subscriber subscribes to multiple email accounts at different email servers; and
the management program sends to the Internet user data concerning the second folder of the multiple email accounts for the particular account subscriber.

6. The system according to claim 1, wherein the particular email account subscriber subscribes to multiple email accounts at different email servers; and
prior to sending the content of the second folder, the management program sends to the Internet user a listing of the second folders of the multiple email accounts for the particular account subscriber.

7. The system according to claim 1, wherein the storage device further stores access authorization for each second folder of each account subscriber and the management program controls access of the each second folder by Internet users according to the stored access authorization.

8. The system according to claim 1, wherein:
the request for information concerning the email account for the particular account subscriber includes an Internet address or an email address; and
the Internet or email address contains the name of the second folder of the email account.

9. The system according to claim 1, further comprising a posting program executed by the processor and operable to:
receive from the Internet user a request to send data to the second folder of the email account; and
send the received data to the second folder of the email account as an email.

10. The system according to claim 9, wherein the posting program sends the received data to the second folder via IMAP or SMTP.

11. The system according to claim 9, wherein the request to send data includes an email address containing the name of the second folder of the email account.

12. A voice message management system comprising:
a storage device having:
a first message box operable to store voice messages for a plurality of account subscribers for later retrieval;
a second message box other than the first message box and operable to store voice messages for the plurality of account subscribers for later retrieval;
a processor;
a message processing program executed by the processor and operable to:
route voice message to either the first or second message box based on the type of the voice messages;
retrieve the stored voice messages in the first and second message box according to subscriber input;

13. The system according to claim 12, wherein the message processing program routes the voice message to the second message box without any alert associated with a telephone call.

14. The system according to claim 12, wherein the voice message contains an identifier that identifies which message box the message is to be routed to.

15. The system according to claim 14, wherein the message processing program receives the voice message as a digitally encoded voice message that contains the identifier.

16. The system according to claim 15, wherein the identifier includes an XML tag that identifies the message box the voice message is to be routed to.

17. The system according to claim 14, wherein the identifier includes an instruction to delete the voice message if the voice message is not retrieved by a subscriber associated with the voice message within a predetermined period of time.

18. The system according to claim 12, wherein the message processing program is further operable to route digital data other than voice messages to the second message box.

19. The system according to claim 12, wherein the message processing program performs authentication of the voice message according to a previously agreed protocol between a sender of the voice message and a provider of the voice message management system.

20. The system according to claim 12, wherein the message processing program is further operable to prompt a subscriber retrieving messages over a telephone line to retrieve messages stored in the second box associated with the subscriber.

21. The system according to claim 12, wherein the message processing program is further operable to allow the subscriber to connect to an advertiser associated with the retrieved message over a communication channel while the subscriber is connected to the voice message management system.

22. The system according to claim 12, wherein the message processing program allows the subscriber to rate the retrieved message and stores the rating in the storage device for analysis.

23. The system according to claim 12, wherein the message processing program is further operable to allow subscribers to retrieve messages stored in the second box through the Internet using an Internet protocol.

24. A management system comprising a system for managing access to folders of email accounts for a plurality of email account subscribers according to claim 1 and a voice message management system according to claim 12.
